(19) United States
(12) Patent Application Publication
(10) Pub. No.: US 2010/0173112 A1
(43) Pub. Date: Jul. 8, 2010

(54) Waterproof Membrane

(76) Inventor: Robert A. Wiercinski, Lincoln, MA (US)

Correspondence Address: W. R. GRACE & CO.-CONN;ATTENTION: PATENT DEPARTMENT, 62 WHITTMORE AVENUE, CAMBRIDGE, MA, 02140, US

(21) Appl. No.: 12/663,085

(22) PCT Filed: Jul. 10, 2008
(86) PCT No.: PCT/US08/69655

§ 371 Date: Dec. 4, 2009

Related U.S. Application Data
(60) Provisional application No. 60/949,066, filed on Jul. 11, 2007.

(51) Int. Cl. B32B 27/12; B32B 33/00; B32B 38/10; E02D 31/02

(52) U.S. Cl. 428/41.8; 156/249; 442/45

(57) ABSTRACT

Described is a waterproofing membrane that, in its most basic form, includes three layers—a flexible substrate layer, a pressure sensitive adhesive layer and a release liner layer. The flexible substrate comprises a woven polyolefin mesh coated on each surface with a polymer film. The polyolefin mesh includes a first plurality of polyolefin tapes extending in a major direction interwoven with a second plurality of polyolefin tapes extending in a cross direction.

### FIELD OF THE INVENTION

The present invention relates to a self-adhering waterproofing membrane, particularly for use in below ground vertical and horizontal applications and above ground wall applications.

### BACKGROUND OF THE INVENTION

Waterproofing membranes are typically installed over surfaces of building structures to protect the structure from moisture penetration. Commercially effective waterproofing membranes must maintain their strength and integrity even after exposure to the elements and must withstand the impact of soil and soil movement.

It is known in the waterproofing art to combine a pre-formed waterproofing membrane, such as a rubberized bitumen/oil layer, with a carrier support sheet or film, and to utilize this as a waterproofing membrane. The carrier support film may comprise a variety of materials, such as rubber, plastic, and/or metal, or combinations of the same. The use of metals is desirable, for example, to improve dimensional stability of the support film, which is subjected to oil migration from the oil-plasticized bitumen layer. It has also been desirable to employ cross-laminated plastic films, such as high density polyethylene, for improved stability of the carrier support sheet.

Such pre-formed waterproofing membrane laminates are considered “sheet-like” because they are sufficiently flexible that they can be rolled up and transported after manufacture to the job site where they are unrolled and installed on the building surface. Conventional waterproofing agents include ethylene propylene diene monomer (EPDM) sheets, polyvinyl chloride sheets, neoprene sheets, bentonite panels, built-up asphalt systems, coal tar-based, and other asphalt-based compositions. Asphalt-based compositions are currently preferred; most preferred are preformed, flexible sheet-like waterproofing laminates of a support film(s) and a bituminous layer(s) such as described in U.S. Pat. Nos. 3,741,856; 3,853,682; 3,900,102; and 5,406,759. Bituthene® brand of waterproofing is an example of a popular commercial membrane. The function of the membrane is to seal cracks and pores in concrete, particular in below ground applications. A commercially available example of a waterproofing membrane is “TRI-FLEX 30”, (a product also available from Grace Construction Products) which is spun-bonded polypropylene coated with a thin layer comprising U.V. stabilized polypropylene on both of its surfaces.

Non-adhering (mechanically fastened) membranes comprising a woven polyolefin mesh are known. Such products include Titanium™ UDL (InterWrap Inc.), Sharkskin™ Comp (Kirsch Building Products, LLC), Sharkskin™ Ultra (Kirsch Building Products, LLC), Polyprotector® UDL (Polyglass USA, Inc.), ROOFTOPGUARD (Nemco Industries Inc.), and Palisade™ Synthetic Membrane (SDP Advanced Polymer Products Inc.). Generally, these products have poor dimensional stability and are particularly subject to excessive shrinkage. FelTex™ membrane (System Components Corporation) is a non-adhering membrane that has an uncoated, woven mesh as the top layer. A waterproofing membrane with an openwork mesh as the bottom surface is disclosed in WO99/40271. Another membrane that includes a woven mesh as an internal structural layer is disclosed in U.S. Pat. No. 6,308,482.

Self-adhering membranes comprising woven fabrics are known. Some of these are extrusion coated on the external side. Commercially available products are made by Interwrap and sold under the trade name Titanium™ PSU. The top surface of the Titanium membrane is textured with nodes which tend to inhibit the formation of watertight laps required for high hydrostatic loads for below grade waterproofing applications. Also the flexible substrate layer of the Titanium membrane comprises a woven polyolefin core in contact with a polymeric grid comprising the nodes. Each side of the woven polyolefin core is extrusion coated with a polyolefin layer. However, the substrate is not balanced with regard to the coefficients of thermal expansion of the elements that make up the substrate layer, thus, rendering the membrane dimensionally unstable and prone to wrinkling It also is prone to discoloration due to absorption of oils from the adhesive layer. Additional details about this product are disclosed in U.S. Pat. No. 6,925,766.

A product sample displayed at a trade show, but not believed to be commercially available, is FelTex™ self-adhering waterproofing membrane (System Components Corporation) that comprises an uncoated polypropylene mesh (24×9) with a thin (about 20 mils or about 0.5 mm), non-bituminous adhesive on the lower surface and a release liner on the adhesive. The woven mesh has no extrusion coating on the top which prevents the formation of watertight laps at high hydrostatic loads.

### SUMMARY OF THE INVENTION

One embodiment of the invention is directed to a dimensionally stable waterproofing membrane. In its most basic form, the waterproofing membrane will comprise three layers—a flexible substrate layer, an adhesive layer and a release liner layer.

One layer comprises a flexible substrate having a first major surface and an opposite second major surface. In use, when the membrane is applied to a substrate, as described later, the first major surface is outwardly exposed and the second major surface faces inwardly toward the substrate. The flexible substrate extends lengthwise in a major direction (MD) and widthwise in a cross direction (CD). The flexible substrate comprises a woven polyolefin mesh comprising a first plurality of polyolefin tapes extending in the MD interwoven with a second plurality of polyolefin tapes extending in the CD. The plurality of tapes in the MD and CD may independently range from 3 to 30 tapes/inch (1.2 to 11.8 tapes/cm). The woven polyolefin mesh is coated on both surfaces with a polymer film. Preferably each polymer film comprises at least 70% polypropylene, most preferably 100% polypropylene, and preferably the two coatings have a similar weight. Thus, the woven polyolefin mesh has a first polymer film coated on one surface of the mesh and a second polymer film coated on the other surface of the mesh, such that the first and second polymer films form the first and second major surfaces of the flexible substrate.

The next layer comprises an adhesive layer affixed to the second major surface of the flexible substrate. The adhesive layer comprises a pressure sensitive adhesive that may be bituminous or non-bituminous. Preferably, it will have a thickness of at least 15 mils (0.38 mm).

The third layer includes a release liner removably affixed to the adhesive layer. The release liner permits the membrane to be stored in a roll, while enabling the user to easily unroll it during application. The release liner is removed just prior to application of the membrane to a substrate surface.

In addition, the present invention includes a method of waterproofing a substrate surface by unrolling the above-described waterproofing membrane, removing the release liner, and adhering the membrane to the substrate surface.

Another embodiment of the invention is a protected waterproofed structure comprising a slip sheet, a dimensionally stable, self-adhering waterproofing membrane comprising a woven polypropylene mesh extrusion coated on both faces with polyolefin layers, and a pressure sensitive adhesive that is adhered to a concrete substrate.

### BRIEF DESCRIPTION OF THE DRAWINGS

FIG. 1 is a schematic diagram of a waterproofing membrane in accordance with one embodiment of the present invention.

FIG. 2 is a schematic diagram of a waterproofing membrane in accordance with the present invention adhered to the surface of a concrete substrate.

FIG. 3 is a schematic diagram of a waterproofing membrane in accordance with the present invention shown in a below ground installation.

### DETAILED DESCRIPTION OF THE PREFERRED EMBODIMENTS

As depicted in FIG. 1, in its most basic form, the waterproofing membrane 1 of the present invention will comprise three layers—a flexible substrate layer 12, an adhesive layer 3 and a release liner layer 4.

One layer comprises a flexible substrate 12 having a first major surface (the upper surface as shown in FIG. 1) adapted to be exposed and an opposite second major surface (the lower surface as shown in FIG. 1) adapted to be applied against (or facing) a substrate surface, such as the surface of a concrete substrate. The flexible substrate extends lengthwise in a major direction (MD) and widthwise in a cross direction (CD). The flexible substrate comprises a woven polyolefin mesh 2 comprising a first plurality of polyolefin tapes extending in the MD interwoven with a second plurality of polyolefin tapes extending in the CD. The plurality of tapes in the MD and CD may independently range from 3 to 30 tapes/inch (1.2 to 11.8 tapes/cm), preferably 5 to 15 tapes/inch (2 to 5.9 tapes/cm). Generally, the ratio of the first plurality to the second plurality is about 0.1:1 to about 10:1, preferably about 1:1 to about 5:1. The polyolefin may comprise polypropylene or polyethylene. Preferably, the polyolefin comprises polypropylene and the flexible substrate will be a woven polypropylene mesh. The polyolefin mesh layer will typically have a thickness in the range of about 2 mils to about 10 mils (about 0.05 mm to about 0.25 mm), preferably about 4 mils to about 8 mils (0.10 mm to 0.20 mm). The weight of the woven polyolefin mesh will typically be in the range of about 20 to 300 g/m², preferably about 40 to 200 g/m².

The woven polyolefin mesh should preferably comprise less than about 20% open space to prevent or minimize potential bleed through of oils from the adhesive through the mesh. (Of course, bleed through is also prevented or reduced by the coated polymer film layers described later.) More preferably, the woven fabric should comprise less than about 10% open space, most preferably less than about 5% open space. The polyolefin mesh layer will typically have a thickness in the range of about 2 mils to about 10 mils (about 0.05 mm to about 0.25 mm), preferably about 4 mils to about 8 mils (0.10 mm to 0.20 mm). The weight of the woven polyolefin mesh will typically be in the range of about 40 to 300 g/m², preferably about 60 to 200 g/m².

The tapes used to produce the mesh are generally produced by first extruding a polyolefin film, orienting the polyolefin film in the machine direction, slitting the film into narrow widths (or tapes), and annealing the tapes. The tapes are then woven into a mesh. If desired, annealing may be done after weaving.

The woven polyolefin mesh 2 has a first mesh surface (e.g., upper surface) and a second mesh surface (e.g., lower surface) and each surface is entirely coated with a polymer film. That is, the woven polyolefin mesh has a first polymer film 6 coated on one surface of the mesh and a second polymer film 5 coated on the other surface of the mesh, such that the first and second polymer films form the first and second major surfaces of the flexible substrate.

The polymer films 5, 6 (which may be the same or different) are applied directly onto each surface of the polyolefin mesh, for example, by extrusion coating with a die, direct roll coater, reverse roll coater, gravure coater, knife over roll coater, etc., followed by cooling, curing or drying. The polymer films 5, 6 may comprise one or more polymers including polyethylene, polypropylene, ethylene-methylacrylate copolymer, and ethylene-butylacrylate copolymer. Preferably, the polymer film is polyethylene or polypropylene or a mixture of polyethylene and polypropylene. If the polymer film is a mixture of polyethylene and polypropylene (e.g., to enhance melt strength), it is generally preferred that the polyethylene comprises no more than 30% of the blend. Preferably, the polyethylene will be low density polyethylene. Ideally, the polymer film will comprise at least 70% polypropylene to improve adhesion to the polyolefin mesh and to minimize oil absorption, and most preferably, the polymer film consists essentially of polypropylene (i.e., about 100% polypropylene).

The weight of application of the coated polymer films 5, 6 is independently 10 g/m² to 100 g/m², preferably 15 g/m² to 40 g/m². It is preferred that the weight of one polymer film is at least 50% of the weight of the other polymer film, more preferably at least 70% of the weight of the other polymer film, and most preferably at least 90% of the weight of the other polymer film. In other words, the weight of the first polymer film may be 50% to 200%, preferably 70% to 143%, most preferably 90% to 111%, of the weight of the second polymer film.

It is highly preferred that the compositions of the polymer films 5, 6 are selected so as to insure that the polymer films have substantially similar to identical coefficients of thermal expansion (CTE) in order to minimize curling or wrinkling of the flexible substrate upon heating. This may be achieved, for example, by using similar to identical compositions for each polymer film. While the CTE for the woven mesh may be somewhat different from that for the two polymer films, the similarity in CTEs for the two polymer films will minimize curling or wrinkling.

It is preferred that the extrusion coated polymer films and the woven polyolefin mesh comprise stabilizers to retard degradation when exposed to direct sunlight. Stabilizers include pigments like carbon black and titanium dioxide. Hindered amine light stabilizers, antioxidants, and ultraviolet absorbers may also be used. Various combinations of these ingredients may be used.

The next layer of the waterproofing membrane comprises an adhesive layer 3 affixed to the second major surface of the flexible substrate 12. The adhesive layer comprises a pressure sensitive adhesive that may be a non-bituminous pressure sensitive adhesive or a rubber modified bitumen pressure sensitive adhesive. Preferably, the adhesive layer will have a thickness of at least 15 mils (0.38 mm), up to about 100 mils (2.5 mm).

Materials suitable for use as the pressure sensitive adhesive layer 3 comprise rubbers such as those selected from the group consisting of SIS (styrene-isoprene-styrene block copolymers), SBS (styrene-butadiene-styrene block copolymers), SEBS (styrene-ethylene-butylene-styrene block copolymers), SBR (styrene-butadiene rubber), natural rubber, silicone rubber, butyl rubber, polyisoprene, polyisobutylene, chloroprene, ethylene-propylene rubber, ethylene alpha olefin, polybutadiene, nitrile rubbers, and acrylic rubber.

A rubber modified bitumen pressure sensitive adhesive may also be used. All of the rubbers listed above, except silicone, may be blended with bitumen to produce a pressure sensitive adhesive. The rubber modified bitumen also typically includes a processing oil such as an aromatic or naphthenic oil. The wt. % rubber is about 10% to 22%; the wt. % bitumen is about 43% to 90%; and the wt. % processing oil is about 0% to 35%. The pressure sensitive adhesive may also comprise an inorganic filler such as silica, calcium carbonate, talc, or clay. If present, the wt. % filler may be about 0% to 30% of the total.

The third layer includes a release liner 4 removably affixed to the adhesive layer 3. The release liner permits the membrane to be stored in a roll, while enabling the user to easily unroll it during application. The release liner may be any material suitable for such use and typically comprises a wax-coated or siliconized paper or plastic film. The release liner is removed just prior to application of the membrane to a substrate surface.

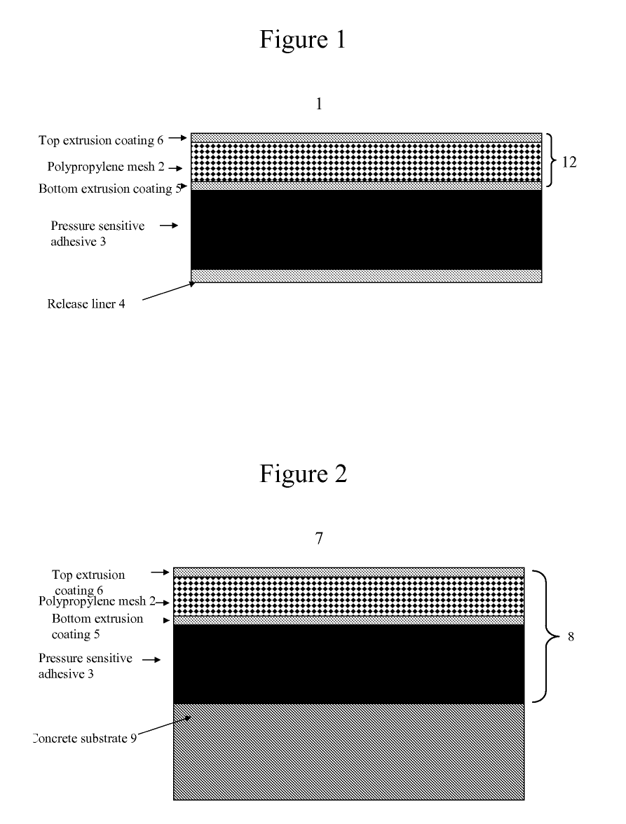

As shown in FIG. 2, the waterproofing membrane 8, after removal of the release liner, may be applied to the surface of a substrate 9, such as the surface of a concrete substrate. The combination of membrane plus substrate results in the waterproofed structure 7. Thus, the present invention includes a method of waterproofing a substrate surface, particularly a concrete substrate surface, by unrolling the above-described waterproofing membrane, removing the release liner, and adhering the membrane to the substrate surface.

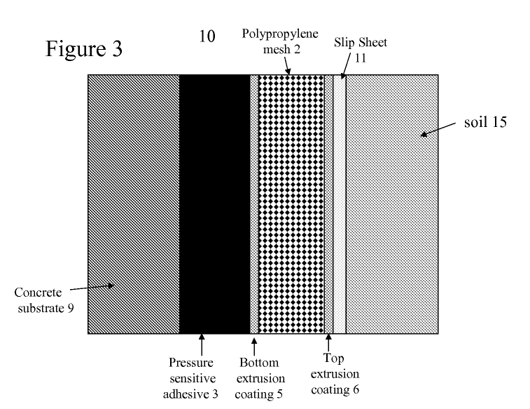

When the substrate surface is below ground (e.g., as with concrete foundations), typically soil or other fill is backfilled against the substrate after the waterproof membrane has been applied. Such an application is depicted in FIG. 3, where it can be seen that soil 15 is filled against the membrane covered substrate. The waterproof membrane of the present invention generally has sufficient strength or impact resistance to prevent being damaged by the backfilled soil. This is because the polymer film coated polyolefin mesh that serves as the flexible substrate is more robust than conventional polyolefin films used on other types of membranes. However, to insure that the membrane is not damaged as a result of movement of the soil, it is preferred to include a slip sheet 11 between the soil and the waterproof membrane. The slip sheet 11 may comprise a paper or plastic film (including, for example, the removed release liner) that is temporarily adhered (e.g., with adhesive tape) to the exposed surface of the waterproofing membrane. Once the soil is backfilled and compacted, the tape may be removed so that the slip sheet may move during any settling of the soil.

One important advantage of the membrane of the present invention is that it has good dimensional stability. This is due to the fact that the flexible substrate 12 and its component elements—namely, the woven polyolefin mesh 2 and the polymer films 5, 6—are selected and/or treated to provide excellent dimensional stability. Good dimensional stability equates with the absence of wrinkling, curling, growth, and excessive shrinkage of the flexible substrate.

Variables that affect dimensional stability of membranes of the present invention include:

(a) The shrinkage characteristics of the flexible substrate. When the membrane is heated, the flexible substrate will expand, which can cause wrinkling The deleterious effects of flexible substrate expansion upon heating can be offset by process induced shrinkage. For example, the method of fabricating the flexible substrate preferably should involve processes that orient the component elements of the flexible substrate such that the substrate, upon heating, will shrink (by the test method described below) 0% to 2% in both the MD and CD to offset any deleterious effects of thermal expansion. If the flexible substrate has no process induced orientation, wrinkling will occur upon heating. On the other hand, excessive shrinkage could compromise waterproofing integrity.

(b) The oil absorption characteristics of the flexible substrate. Oil absorption of the woven polyolefin mesh and/or the coated polymer film layers causes expansion and wrinkling Oil absorption is facilitated by heating. Polypropylene is resistant to oil absorption in comparison to some other polyolefins that may be used to produce the component elements of the flexible substrate, particularly polyethylene. In addition, the woven polypropylene mesh is highly crystalline as a result of the manufacturing process and the crystalline regions do not absorb oil. Hence polypropylene is preferred to reduce oil absorption and enhance dimensional stability.

(c) The balance of coefficient of thermal expansion (CTE) characteristics of the flexible substrate. The flexible substrate of the present invention is balanced in regard to the coefficients of thermal expansion of the flexible substrate elements, namely the woven polyolefin mesh and the coated polymer film layers. The two polyolefin extrusion coated layers have the same CTE if they essentially comprise the same material and are manufactured by the same process. The CTE for the woven polyolefin mesh may be somewhat lower as a result of higher crystallinity. But, overall, the CTE of the flexible substrate is balanced. As a result it will not curl or wrinkle when heated.

The dimensional stability of the membrane may be evaluated by adhering a 3 ft.×7 ft. (91.4 cm×213.4 cm) sample to a sheet of plywood, fixing one narrow end with a batten strip, measuring the length and width precisely at several locations, heating for 24 hours in a still oven at 180° F. (82° C.), cooling to room temperature, remeasuring the length and width precisely at the same locations, and calculating the average % shrinkage. Note is also made of any wrinkling or curling. Preferably, the shrinkage in the MD should be 0% to 2%, more preferably 0% to 1%, to insure good dimensional stability. Preferably, the shrinkage in the CD should be 0% to 2%, more preferably 0% to 1%. Preferably, any growth in either the MD or CD should be 0% to 1%, most preferably about 0%. Preferably there is no wrinkling or curling exhibited, or the level of wrinkling or curling is minimal.

### EXAMPLE 1

A membrane with the construction depicted in FIG. 1 was fabricated. Mesh 2 is a 66 g/m² woven polypropylene mesh having 9.1 tapes/in. (3.6 tapes/cm) in the MD and 7.6 tapes/in. (3 tapes/cm) in the CD. The mesh has extrusion coated polymer films 5 and 6 comprised of a 24 g/m² and 33 g/m², respectively, of polypropylene. Adhesive layer 3 is 36 mils (0.91 mm) of a rubber modified bitumen pressure sensitive adhesive (21% SBS rubber, 30% aromatic oil and 49% bitumen). Release liner 4 is 6 mil silicone coated paper. The membrane is made by coating a hot melt of the modified bitumen adhesive onto the release liner, cooling the adhesive, then laminating the extrusion coated polypropylene mesh to the adhesive.

What is claimed is:

1. 1. A waterproofing membrane comprising
a flexible substrate having a first major surface and an opposite second major surface, the flexible substrate extending lengthwise in a major direction (MD) and widthwise in a cross direction (CD), wherein the flexible substrate comprises a woven polyolefin mesh comprising a first plurality of polyolefin tapes extending in the MD interwoven with a second plurality of polyolefin tapes extending in the CD; wherein the woven polyolefin mesh has a first polymer film coated on one surface of the mesh and a second polymer film coated on the other surface of the mesh, such that the first and second polymer films form the first and second major surfaces of the flexible substrate;
an adhesive layer affixed to said second major surface, wherein the adhesive layer comprises a pressure sensitive adhesive with a thickness of at least 15 mils (038 mm); and
a release liner removably affixed to the adhesive layer.

2. The membrane of claim 1, wherein the first plurality of tapes and the second plurality of tapes independently comprise about 3 to 30 tapes/inch (1.2 to 11.8 tapes/cm).

3. The membrane of claim 2, wherein the ratio of the first plurality to the second plurality is about 0.1:1 to about 10:1.

4. The membrane of claim 1, wherein the first plurality of tapes and the second plurality of tapes independently comprise about 5 to 15 tapes/inch (2 to 5:9 tapes/cm).

5. The membrane of claim 4, wherein the ratio of the first plurality to the second plurality is about 1:1 to about 5:1.

6. The membrane of claim 1, wherein the first polymer film and the second polymer film may be the same or different and independently comprise one or more polymers selected from polyethylene, polypropylene, ethylene-methylacrylate copolymer, and ethylene-butylacrylate copolymer.

7. The membrane of claim 1, wherein the first polymer film and the second polymer film may be the same or different and independently comprise polyethylene, polypropylene, or a mixture of polyethylene and polypropylene.

8. The membrane of claim 1, wherein the first polymer film and the second polymer film each comprise at least 70% polypropylene.

9. The membrane of claim 1, wherein the first polymer film and the second polymer film each consist essentially of polypropylene.

10. The membrane of claim 8, wherein the weight of the first polymer film and the second polymer film is independently 10 g/m² to 100 g/m².

11. The membrane of claim 10, wherein the weight of the first polymer film is about 50% to about 200% of the weight of the second polymer film.

12. The membrane of claim 8, wherein the weight of the first polymer film and the second polymer film is independently 15 g/m² to 40 g/m².

13. The membrane of claim 12, wherein the weight of the first polymer film is about 70% to about 143% of the weight of the second polymer film.

14. The membrane of claim 12, wherein the weight of the first polymer film is about 90% to about 111% of the weight of the second polymer film.

15. The membrane of claim 1, wherein the first polymer film and the second polymer film have substantially similar coefficients of thermal expansion.

16. The membrane of claim 1, wherein the pressure sensitive adhesive comprises one or more rubbers selected from the group consisting of SIS (styrene-isoprene-styrene block copolymers), SBS (styrene-butadiene-styrene block copolymers), SEBS (styrene-ethylene-butylene-styrene block copolymers), SBR (styrene-butadiene rubber), natural rubber, silicone rubber, butyl rubber, polyisoprene, polyisobutylene, chloroprene, ethylene-propylene rubber, ethylene alpha olefin, polybutadiene, nitrile rubber, and acrylic rubber.

17. The membrane of claim 1, wherein the pressure sensitive adhesive comprises rubber modified bitumen.

18. The membrane of claim 1, wherein the membrane exhibits about 0% growth in the MD and exhibits shrinkage in the MD of 0% to 2% alter heating the sample at 180′ F. (82° C.) for 24 hours, then cooling it to room temperature.

19. The membrane of claim 18, wherein the membrane exhibits shrinkage in the MD of 0% to 1%.

20. The membrane of claim 18, wherein the membrane exhibits about 0% growth in the CD and exhibits shrinkage in the CD of 0% to 2%.

21. The membrane of claim 20, wherein the membrane exhibits shrinkage in the CD of 0% to 1%.

22. The membrane of claim 1, wherein the woven polyolefin mesh comprises woven polypropylene.

23. The membrane of claim 1 wherein the weight of the woven polyolefin mesh is 20 g/m² to 300 g/m².

24. The membrane of claim I wherein the weight of the woven polyolefin mesh is 40 g/m² to 200 g/m².

25. A method of waterproofing a substrate comprising removing the release liner from the waterproofing membrane according to claim 1 and adhering the membrane to a surface of the substrate.

26. A waterproofed structure comprising a substrate having a surface and a waterproofing membrane according to claim 1, without the release liner, affixed to the surface of the substrate.

27. The waterproofed structure of claim 26 additionally comprising a slip sheet movably installed adjacent the waterproofing membrane to prevent damage to the membrane by movement of soil filled against the membrane.
